(19) United States
(12) Patent Application Publication
(10) Pub. No.: US 2026/0100916 A1
(43) Pub. Date: Apr. 9, 2026

(54) MULTI-LEVEL LINK AGGREGATION GROUPS

(71) Applicant: HEWLETT PACKARD ENTERPRISE DEVELOPMENT LP, Spring, TX (US)

(72) Inventors: Shiva Kumar Krishna Rao, Bangalore (IN); Mallikarjuna V. Shivakumar, Bangalore (IN)

(21) Appl. No.: 18/966,960

(22) Filed: Dec. 3, 2024

(30) Foreign Application Priority Data
Oct. 3, 2024 (IN) 202441075608

(51) Int. Cl. H04L 47/41; H04L 47/762

(52) U.S. Cl. CPC H04L 47/41; H04L 47/762

(57) ABSTRACT

A network device is provided. During operation, the network device can operate a first link-aggregation group (LAG) comprising a first set of links between the network device and a second network device. The first set of links can operate as an aggregated link between the network device and the second network device. The network device can operate a second LAG comprising the first LAG and at least a high-capacity link between the network device and the second network device. The capacity of the high-capacity link can match the combined capacity of the first LAG. The network device can determine the first and second control packets received at the first network device to be associated with the first and second LAGs, respectively, based on an indicator in the second control packet. The network device can then configure the first and second LAGs based on the first and second control packets, respectively.

### BACKGROUND

A network device, such as a switch, may be deployed in different network topologies. In some cases, the network device can be deployed in a link aggregation group (LAG), which can operate as an aggregated link to a peer network device.

### BRIEF DESCRIPTION OF THE FIGURES

FIG. 1A illustrates an example of a multi-level LAG (ML-LAG) operating based on dynamic LAG formation, in accordance with an aspect of the present application.

FIG. 1B illustrates an example of a plurality of ML-LAGs formed based on dynamic LAG formation, in accordance with an aspect of the present application.

FIG. 1C illustrates an example of an ML-LAG formed based on static LAG formation, in accordance with an aspect of the present application.

FIG. 2 illustrates an example of a sequence of configurations for forming an ML-LAG, in accordance with an aspect of the present application.

FIG. 3 presents a flowchart illustrating an example of a process of a network device operating an ML-LAG, in accordance with an aspect of the present application.

FIG. 4 presents a flowchart illustrating an example of a process of a network device distinguishing between control packets associated with an ML-LAG, in accordance with an aspect of the present application.

FIG. 5 presents a flowchart illustrating an example of a process of a network device operating a plurality of ML-LAGs, in accordance with an aspect of the present application.

FIG. 6 illustrates an example of a computing system supporting an ML-LAG between network devices, in accordance with an aspect of the present application.

FIG. 7 illustrates an example of a computer-readable medium (CRM) supporting an ML-LAG between network devices, in accordance with an aspect of the present application.

In the figures, like reference numerals refer to the same figure elements.

### DETAILED DESCRIPTION

In a network, two network devices (can be referred to as peer network devices or peer devices) can be coupled to each other via a plurality of links. These links can be grouped together to operate as a logical or virtual link, which is referred to as a LAG. The ports coupling each of these links can be referred to as LAG ports.

These LAG ports can reside on their respective network interface controllers or cards (NICs) of the peer devices. Typically, a respective peer network device can be coupled to user devices (e.g., a personal device, such as a computer or a server) and can provide access to these user devices. The user devices can be coupled to the peer devices via corresponding links. The peer devices can aggregate traffic from the user devices and forward the aggregated traffic to an external network, such as a wide-area network (WAN) (e.g., the Internet).

The peer devices can run a LAG control protocol (e.g., Link Aggregation Control Protocol (LACP)) that can exchange control information between the network devices via control packets. A control packet may include configuration information indicating the LAG ports. The configuration information can include, but is not limited to, port capacity (e.g., data transmission rate), duplex mode, flow control mechanism, maximum frame size, and virtual local area network (VLAN) membership information. Therefore, by exchanging the configuration information, the network devices can ensure that the respective configurations of the LAG ports conform to each other and, as a result, LAGs are often formed between NICs of the same capacity.

The aspects described herein address the problem of efficiently forming a high-capacity LAG between two network devices spanning multiple NIC pairs by (i) operating an underlay LAG with a plurality of links between a NIC pair of the network devices; and (ii) operating a multi-level LAG (ML-LAG) with the underlay LAG and at least one link between another NIC pair of the network devices. Here, the aggregated capacity of the underlay LAG can correspond to the link in the ML-LAG. As a result, the underlay LAG can appear as a single link (e.g., an aggregated virtual link) in the ML-LAG between one NIC pair and form the ML-LAG with the other link between the other NIC pair. In this way, the ML-LAG can span multiple NIC pairs.

Typically, a network device can include a high-capacity NIC (e.g., with a set of high-capacity ports, such as 40 Gbps ports) for upstream communication. The network device may also include a few low-capacity NICs (e.g., with a set of low-capacity ports, such as 10 Gbps ports) for downstream communication. For example, the low-capacity ports can be coupled to user devices, and a subset of the high-capacity ports can be coupled to an upstream network (e.g., a WAN, such as the Internet). The network device can aggregate traffic received from the low-capacity ports and forward the aggregated traffic through the high-capacity ports. Since the price of a high-capacity NIC can be significantly higher than the price of a low-capacity NIC, the network device may be equipped with one high-capacity NIC for supporting aggregated traffic forwarding.

Usually, ports of the high-capacity NICs are used to form a LAG, which aggregates multiple links from two or more peer network devices (or peer devices). If a link in the LAG becomes unavailable, other links can continue to operate, which provides high availability for the LAG. However, if the LAG is formed using one NIC and the NIC becomes unavailable, the entire LAG can become unavailable. If the LAG spans multiple NICs, the LAG can continue to operate if one or the NICs fails. Nonetheless, the current LAG technology, such as the LAG control protocol, may not support combining NICs of different data rates. As a result, a current LAG may not span multiple NICs due to the limited number of high-capacity NICs. Consequently, the current LAG may not facilitate high availability in the event of a NIC failure.

To address this issue, an ML-LAG can span a low-capacity device pair and a high-capacity device pair of the peer devices. A first-level LAG can be formed using a plurality of low-capacity links between the low-capacity NIC pair at the respective peer devices. The first-level LAG can operate as a virtual link with the aggregated capacities of the LAG ports. If there are X links in the first-level LAG, and the capacity or transmission rate of a respective LAG port is Y Gbps, the capacity of the virtual link can be X*Y Gbps. This virtual link can then be used as a link in a second-level LAG using at least one high-capacity link between the high-capacity NIC pair at the respective peer devices. The capacity of the high-capacity link in the second-level LAG can correspond to the first-level LAG. Therefore, the capacity or transmission rate of the high-capacity link can be X*Y Gbps. In this way, the second-level LAG can be an ML-LAG, whereas the first-level LAG can operate as an underlay LAG. The ML-LAG can, therefore, accommodate NICs with different capacities, thereby improving the flexibility and interoperability of the ML-LAG.

For example, a respective low-capacity NIC of a peer device can be equipped with a plurality of 10 Gbps ports, and the high-capacity NIC of the peer device can be equipped with a plurality of 40 Gbps ports. Therefore, a low-capacity link formed between the low-capacity NIC pair of the peer devices can have a capacity of 10 Gbps. Furthermore, a high-capacity link formed between the high-capacity NIC pair of the peer devices can have a capacity of 40 Gbps. To match the high capacity of a link, there can be four 10 Gbps links in the underlay LAG. Therefore, the aggregated capacity of the underlay LAG can be 40 Gbps. Accordingly, the underlay LAG can operate as a virtual 40 Gbps link in the ML-LAG. The ML-LAG can aggregate at least one 40 Gbps high-capacity link between the high-capacity NIC pair. Therefore, the capacity of the ML-LAG can be at least 80 Gbps.

In some examples, the underlay LAG can be formed and operated dynamically by the peer devices. A respective peer device can run a LAG control protocol instance, such as an LACP instance. The ports of the low-capacity NIC pair that participate in the underlay LAG can exchange control packets of the LAG control protocol to dynamically form the underlay LAG. The control packets can include configuration information based on which the underlay LAG can be formed. If the LAG control protocol is LACP, the low-capacity NIC pair can exchange Protocol Data Units (PDUs) of the LACP instance. The underlay LAG may also be formed based on static configurations where an administrator may configure a respective port participating in the underlay LAG. The underlay LAG can then be formed and operated without exchanging the control packets.

The ML-LAG can then be formed between the peer devices. The ML-LAG can include at least one link between respective high-capacity NICs and the underlay LAG. A set of ports, which can participate in the underlay LAG, of the low-capacity NIC pair and at least one port, which can participate in the ML-LAG, of the high-capacity NIC pair can exchange control packets of the LAG control protocol to dynamically form the ML-LAG. If the underlay LAG is statically formed, the low-capacity NIC may not receive control packets associated with the underlay LAG. Accordingly, the low-capacity NIC may only receive control packets associated with the ML-LAG.

On the other hand, if the underlay LAG is dynamically formed, the low-capacity NIC may receive control packets associated with both the underlay LAG and the ML-LAG. In particular, since the underlay LAG is included in the ML-LAG, a port in the underlay LAG (i.e., a port in the low-capacity NIC) can be present in both the underlay LAG and ML-LAG. As a result, the port may receive control packets associated with both LAGs. To distinguish between the control packets of these LAGs, the control packets associated with the ML-LAG can include an indicator indicating it to be associated with the ML-LAG. In some examples, the indicator can be a VLAN identifier. Typically, a range of VLANs can be reserved for internal usage at the peer devices. When the ML-LAG is formed, an internal VLAN can be associated with the ML-LAG. The VLAN identifier can then be associated with the internal VLAN. Furthermore, if a plurality of ML-LAGs can be formed between the peer devices, each ML-LAG can be associated with a distinct internal VLAN. Based on the corresponding VLAN identifiers of distinct internal VLANs, the peer devices can distinguish the control packets of different ML-LAGs at the same peer device.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

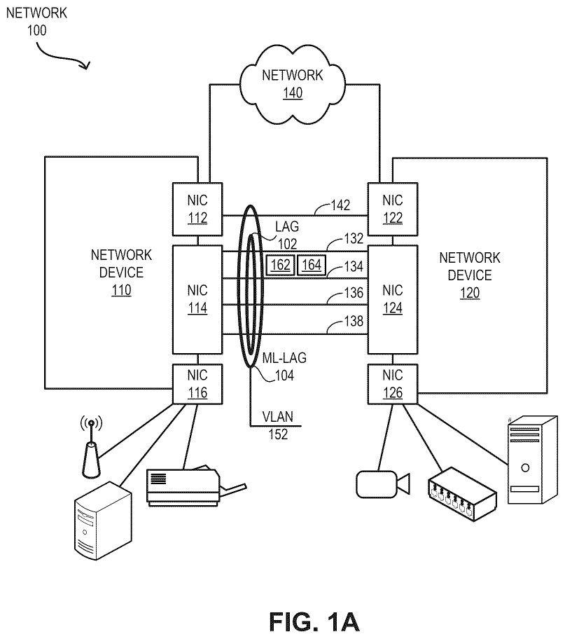

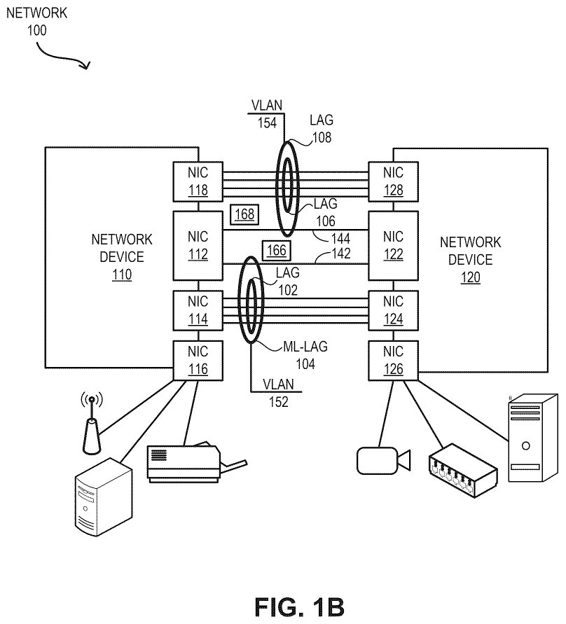

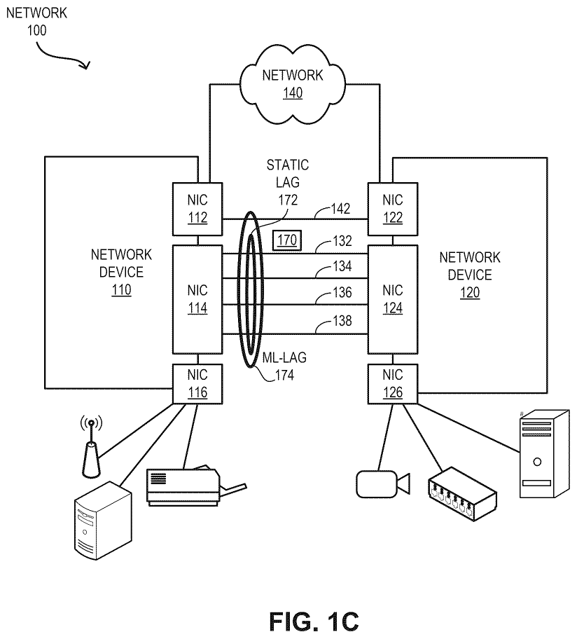

FIG. 1A illustrates an example of a multi-level LAG (ML-LAG) operating based on dynamic LAG formation, in accordance with an aspect of the present application. A network 100 can include a number of network devices (e.g., switches), and may include network components, such as layer-2 and layer-3 hops, and tunnels. In some examples, network 100 can be an Ethernet network, InfiniBand network, or other network, and may use a corresponding network communication protocol, such as IP, FibreChannel over Ethernet (FCoE), or other protocols. Network 100 can include network devices 110 and 120. A respective network device in network 100 can be associated with a MAC address and an IP address and can include at least one processing resource. Examples of a processing resource can include, but are not limited to, a processor core, a graphics processing unit (GPU), and a tensor processing unit (TPU).

Network device 110 can include a high-capacity NIC 112 and low-capacity NICs 114 and 116, and network device 120 can include a high-capacity NIC 122 and low-capacity NICs 124 and 126. Each of high-capacity NICs 112 and 122 can include a set of high-capacity ports (e.g., N Gbps ports, such as 40 Gbps ports), and each of low-capacity NICs 114, 116, 124, and 126 can include a set of low-capacity ports (e.g., M Gbps ports where N>M, such as 10 Gbps ports). In this example, the low-capacity ports of NICs 116 and 126 can be coupled to a set of user devices. Furthermore, NICs 112 and 122 can be coupled to an upstream network 140 (e.g., a WAN, such as the Internet). Network devices 110 and 120 can aggregate traffic received from NICs 116 and 126 and can forward the aggregated traffic through NICs 112 and 122 to network 140. Since the price of NIC 112 can be significantly higher than the price of NIC 114 or 116, network device 110 may be equipped with one high-capacity NIC 112 for supporting aggregated traffic forwarding. Similarly, network device 120 may be equipped with one high-capacity NIC 122.

Usually, ports of NICs 112 and 122 are used to form a LAG, which aggregates multiple links between peer devices 110 and 120. If a link in the LAG becomes unavailable, other links can continue to operate, which provides high availability for the LAG. However, if the LAG is formed between NICs 112 and 122, and one of NICs 112 and 122 becomes unavailable, the entire LAG can become unavailable. In other words, since the LAG is formed using a single NIC on a respective peer device (i.e., peer devices 110 and 120), failure at NIC 112 or 122 can cause the LAG to fail. Furthermore, the current LAG technology, such as the LAG control protocol (e.g., LACP), may not support forming LAGs spanning NICs of different capacities. Consequently, the LAG control protocol may not support a LAG spanning NICs 112 and 114 (or 116) on network device 110 and NICs 122 and 124 (or 126) on network device 120. Such a LAG may not facilitate high availability in the event of a NIC failure.

To address this issue, an underlay LAG 102 can be formed comprising links 132, 134, 136, and 138 between NICs 114 and 124 at peer devices 110 and 120, respectively. LAG 102 can operate as a virtual link with the aggregated capacities of links 132, 134, 136, and 138. To send a packet to peer device 120, peer device 110 can use one of the links 132, 134, 136, and 138 and send the packet via the selected link. Peer device 110 may apply a selection mechanism, such as round robin, load balancing, or hashing, on the packet to select the link. Since all of these links can be used in parallel, if the capacity of each of these links is Y Gbps, the capacity of the virtual link corresponding to LAG 102 can be 4 Y Gbps. This virtual link can then be used as a link in ML-LAG 104, which can also include link 142 between NICs 112 and 122. In this way, ML-LAG 104 can span NICs 112 and 114 on network device 110 and NICs 122 and 124 on network device 120. The capacity of link 142 can correspond to the aggregated capacity of LAG 102 (e.g., 4 Y Gbps). ML-LAG 104 can, therefore, accommodate NICs of different capacities and facilitate high availability.

If the capacity of NICs 114, 116, 124, and 126 is 10 Gbps, the capacity or transmission rate of a respective port on these NICs can be 10 Gbps. Furthermore, if the capacity of NICs 112 and 122 is 40 Gbps, the capacity or transmission rate of a respective port on these NICs can be 40 Gbps. As a result, the capacity of links 132 and 142 can be 10 Gbps and 40 Gbps, respectively. Since the capacity of link 142 is four times the capacity of link 132, to match the capacity of link 142, there can be four 10 Gbps links 132, 134, 136, and 138 in LAG 102. Therefore, the aggregated capacity of LAG 102 can be 40 Gbps. Accordingly, LAG 102 can operate as a virtual 40 Gbps link in ML-LAG 104. ML-LAG can include 40 Gbps link 142. Therefore, the aggregate capacity of ML-LAG 104 can be at least 80 Gbps.

In some examples, LAG 102 can be formed and operated dynamically by peer devices 110 and 120. Peer devices 110 and 120 can run a LAG control protocol instance, such as an LACP instance. NICs 114 and 124, which participate in LAG 102, can exchange control packets of the LAG control protocol to dynamically form LAG 102. The control packets can include configuration information based on which LAG 102 can be formed. If the LAG control protocol is LACP, NICs 114 and 124 can exchange PDUs of the LACP instance running on peer devices 110 and 120. The PDUs can include configuration information associated with the ports coupled to links 132, 134, 136, and 138. For a respective port, the configuration information can include port capacity or transmission rate, duplex mode, flow control mechanism, maximum frame size, and VLAN membership information. When network device 110 receives the PDUs from network device 120, network device 110 can determine which ports are to be in LAG 102 and their corresponding configurations. Accordingly, network device 110 can bundle the ports as one end of LAG 102. Similarly, based on the PDUs from network device 110, network device 120 can bundle the ports of the other end of LAG 102.

Here, network devices 110 and 120 can ensure that the respective configurations of the LAG ports conform to each other. For example, the configurations of the two ports coupled to link 132 should conform to each other (e.g., has the same capacity and VLAN configurations). Subsequently, network devices 110 and 120 can start exchanging data over LAG 102. In the same way, NICs 114 and 124 and NICs 112 and 122 can exchange control packets to dynamically form ML-LAG 104 between peer devices 110 and 120.

Therefore, NICs 114 and 124 may exchange control packets associated with both LAG 102 and ML-LAG 104. Since LAG 102 is included in ML-LAG 104, a port in LAG 102 (i.e., a port in NIC 114) can be present in both LAG 102 and ML-LAG 104. As a result, the port may receive control packets associated with both LAGs. For example, NIC 114 can receive a control packet (e.g., LACP PDU) 162 associated with LAG 102 and another control packet 164 associated with ML-LAG 104. To determine which control packet is associated with which LAG (i.e., to distinguish between packets 162 and 164), packet 164 can include an indicator indicating it to be associated with ML-LAG 104. In some examples, the indicator can include an identifier of a VLAN 152. Typically, a range of VLANs can be reserved for internal usage at peer devices 110 and 120. When ML-LAG 104 is formed, internal VLAN 152 can be associated with ML-LAG 104. The identifier of internal VLAN 152 can then be included in packet 164. Upon receiving packet 164, peer device 110 can determine the presence of the indicator in packet 164 and determine that packet 164 is associated with ML-LAG 104.

If a link, such as link 132, LAG 102 becomes unavailable, the total capacity of LAG 102 becomes lower than the capacity of link 142 in ML-LAG 104. For example, if the capacity of link 132 is Y Gbps, the capacity of LAG 102 and link 142 can be 4 Y Gbps. However, if link 132 becomes unavailable, the capacity of LAG 102 becomes 3 Y Gbps. As a result, the virtual link representing LAG 102 may no longer be compatible with link 142, and hence, becomes unavailable in ML-LAG 104. When link 132 becomes available, the capacity of the virtual link representing LAG 102 can again be 4 Y Gbps. Therefore, LAG 102 can rejoin ML-LAG 104.

FIG. 1B illustrates an example of a plurality of ML-LAGs formed based on dynamic LAG formation, in accordance with an aspect of the present application. In this example, peer device 110 can be equipped with NICs 112, 114, 116, and 118, where NIC 112 can be a high-capacity NIC and the rest can be low-capacity NICs. Similarly, peer device 120 can be equipped with NICs 122, 124, 126, and 128, where NIC 122 can be a high-capacity NIC and the rest can be low-capacity NICs. Peer devices 110 and 120 can have a plurality of ML-LAGs 104 and 108 between them. Here, ML-LAG 108 can span NICs 112 and 118 on peer device 110 and NICs 122 and 128 on peer device 120.

A LAG 106 can be formed using a plurality of low-capacity links between NICs 118 and 128. LAG 106 can operate as a virtual link with the aggregated capacities of the LAG ports. This virtual link can then be used as a link in ML-LAG 108, which can also include link 144 between NICs 112 and 122. In this way, LAG 106 can be the underlay LAG for ML-LAG 108. Since there can be a plurality of ML-LAGs between peer devices 110 and 120, each of ML-LAGs 104 and 108 can be associated with internal VLANs 152 and 154, respectively. Based on VLANs 152 and 154, the control packets of ML-LAGs 104 and 108, respectively, at the same peer device 110 or 120.

For example, NIC 112 can receive a control packet (e.g., LACP PDU) 166 associated with ML-LAG 104 and another control packet 168 associated with ML-LAG 108 . To determine which control packet is associated with which ML-LAG (i.e., to distinguish between packets 166 and 168), packets 166 and 168 can include respective indicators indicating them to be associated with ML-LAGs 104 and 108, respectively. In some examples, the indicators can include respective identifiers of internal VLANs 152 and 154. When ML-LAG 108 is formed, internal VLAN 154 can be associated with ML-LAG 108 . The identifiers of internal VLANs 152 and 154 can then be included in packets 166 and 168, respectively. Upon receiving packet 166, peer device 110 can determine that packet 166 is associated with ML-LAG 104 based on the presence of the identifier of VLAN 152. Similarly, upon receiving packet 168, peer device 110 can determine that packet 168 is associated with ML-LAG 108 based on the presence of the identifier of VLAN 154. In this way, peer device 110 can distinguish between packets 166 and 168 based on VLANs 152 and 154, respectively.

FIG. 1C illustrates an example of an ML-LAG formed based on static LAG formation, in accordance with an aspect of the present application. In this example, peer device 110 can be equipped with NICs 112, 114, and 116, where NIC 112 can be a high-capacity NIC and the rest can be low-capacity NICs. Similarly, peer device 120 can be equipped with NICs 122, 124, and 126, where NIC 122 can be a high-capacity NIC, and the rest can be low-capacity NICs. An underlay LAG 172 can be formed comprising links 132, 134, 136, and 138 between NICs 114 and 124 at peer devices 110 and 120, respectively. LAG 172 can operate as a virtual link with the aggregated capacities of links 132, 134, 136, and 138. This virtual link can then be used as a link in ML-LAG 174, which can also include link 142 between NICs 112 and 122. In this way, ML-LAG 174 can span NICs 112 and 114 on network device 110 and NICs 122 and 124 on network device 120.

Underlay LAG 172 may be formed based on static configurations where an administrator may configure a respective port participating in underlay LAG 172. For example, the administrator may configure port capacity (e.g., data transmission rate), duplex mode, flow control mechanism, maximum frame size, and VLAN membership information associated with a respective port in LAG 172. Therefore, LAG 172 can then be formed and operated without exchanging the control packets. Since LAG 172 can be statically formed, NICs 114 and 124 may not receive control packets associated with LAG 172. However, ML-LAG 174 may be formed based on the LAG control protocol. To allow the dynamic formation of ML-LAG 174, ports in LAG 172 can support the exchange of control packets of ML-LAG 174 even though they participate in a static LAG. In other words, control packet exchange can be enabled for the ports participating in LAG 172. Hence, NIC 114 may only receive control packets associated with ML-LAG 174. For example, NIC 114 can receive a control packet 170 via link 132 and determine that packet 170 is associated with ML-LAG 174 since NIC 114 may not receive control packets for LAG 172. Accordingly, when NIC 114 receives a control packet, peer device 110 can determine that the control packet is associated with ML-LAG 174.

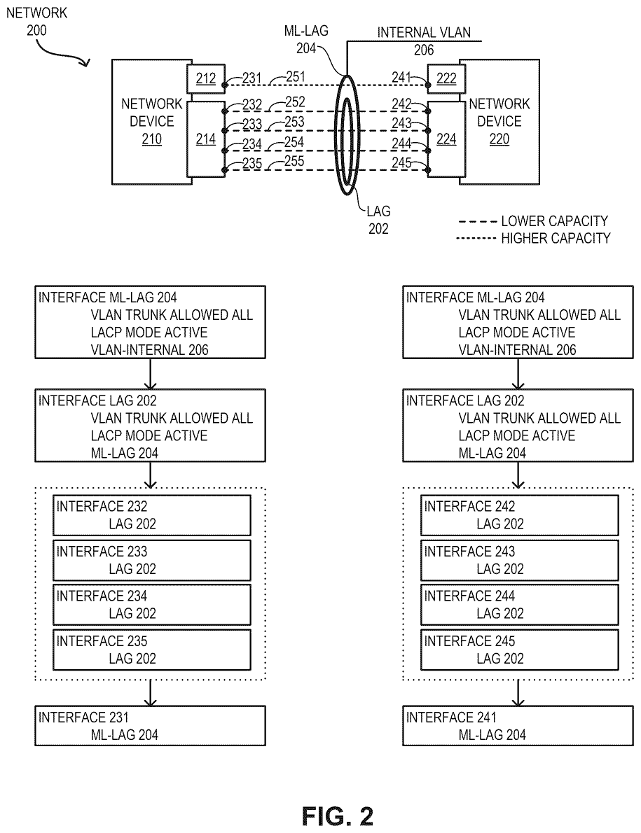

FIG. 2 illustrates an example of a sequence of configurations for forming an ML-LAG, in accordance with an aspect of the present application. A network 200 can include a number of network devices (e.g., switches), and may include network components, such as layer-2 and layer-3 hops, and tunnels. In some examples, network 200 can be an Ethernet network, InfiniBand network, or other network, and may use a corresponding network communication protocol, such as IP, FibreChannel over Ethernet (FCoE), or other protocols. Network 200 can include network devices 210 and 220. A respective network device in network 200 can be associated with a MAC address and an IP address and can include at least one processing resource.

Examples of a processing resource can include, but are not limited to, a processor core, GPU, and a TPU.

Network device 210 can include a high-capacity NIC 212 and at least one low-capacity NIC 214, and network device 120 can include a high-capacity NIC 222 and at least one low-capacity NIC 224. NIC 212 can include a set of high-capacity ports, such as port 231. Similarly, NIC 222 can include a set of high-capacity ports, such as port 241. NIC 214 can include a set of low-capacity ports, such as ports 232, 233, 234, and 235. Similarly, NIC 224 can include a set of low-capacity ports, such as ports 242, 243, 244, and 245. Underlay LAG 202 can be formed comprising links 252, 253, 254, and 255 between NICs 214 and 224 at peer devices 110 and 120, respectively. Here, link 252 can be formed between ports 232 and 242, link 253 can be formed between ports 233 and 243, link 254 can be formed between ports 234 and 244, and link 255 can be formed between ports 235 and 245.

LAG 202 can operate as a virtual link with the aggregated capacities of links 252, 253, 254, and 255. This virtual link can then be used as a link in ML-LAG 204, which can also include link 251 between ports 231 and 241. In this way, ML-LAG 204 can span NICs 212 and 214 on network device 210 and NICs 222 and 224 on network device 220. When ML-LAG 204 is formed, internal VLAN 206 can be associated with ML-LAG 204. To form ML-LAG 204, which can incorporate LAG 202, an administrator can provide a sequence of configurations (e.g., based on corresponding configuration commands) to network devices 210 and 220. Based on the sequence of configurations, network devices 210 and 220 can dynamically form LAG 202 and LAG 204.

In the sequence of configurations on network device 210, the administrator can configure ML-LAG 204, configure LAG 202 indicating it to be a part of ML-LAG 204, configure ports 232, 233, 234, and 235 as interfaces of LAG 202, and configure port 231 as an interface of ML-LAG 204. Similarly, on network device 220, the administrator can configure ML-LAG 204, configure LAG 202 indicating it to be a part of ML-LAG 204, configure ports 242, 243, 244, and 245 as interfaces of LAG 202, and configure port 241 as an interface of ML-LAG 204. Configuring ML-LAG 204 can include specifying which VLANs are allowed over ML-LAG 204 (e.g., all VLANs are allowed), activating a LAG protocol (e.g., activating LACP) over ML-LAG 204, and allocating an internal VLAN, such as VLAN 206, to ML-LAG 204. Furthermore, configuring LAG 202 can also include specifying which VLANs are allowed over LAG 202 (e.g., all VLANs are allowed) and activating a LAG protocol (e.g., activating LACP) over LAG 202.

When the configurations are complete, the LAG control protocol instances on network devices 210 and 220 can exchange control packets (e.g., LACP PDUs) via ports 232 and 242, 233 and 243, 234 and 244, and 235 and 245, respectively, to form LAG 202. Since LAG 202 is in ML-LAG 204, the LAG control protocol instances on network devices 210 and 220 can also exchange control packets (e.g., LACP PDUs) via ports 231 and 241, 232 and 242, 233 and 243, 234 and 244, and 235 and 245, respectively, to form ML-LAG 204. When network device 210 receives a control packet via port 232, network device 210 may determine whether the control packet includes an indicator. If the control packet includes the indicator, network device 210 can determine that the control packet is associated with ML-LAG 204. On the other hand, if the indicator is not present, the control packet can be associated with LAG 202. In this way, network device 210 can distinguish between the respective control packets of LAG 202 and ML-LAG 204.

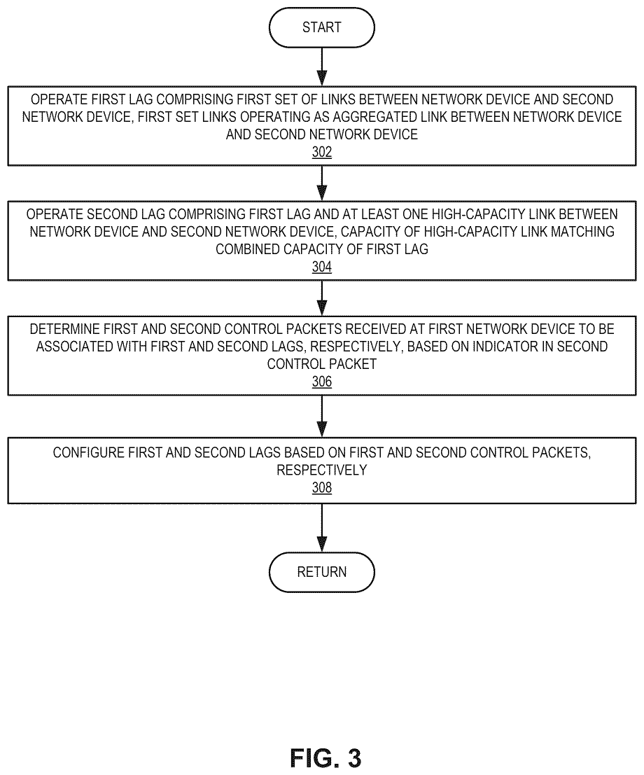

FIG. 3 presents a flowchart illustrating an example of a process of a network device operating an ML-LAG, in accordance with an aspect of the present application. During operation, the network device can operate a first LAG comprising a first set of links between the network device and the second network device (operation 302). Here, the first set of links as an aggregated link (e.g., a virtual or logical link) between the network device and the second network device. To operate the first LAG, the network device can send packets to the second network device at an aggregated data rate of the links in the first LAG. For example, the network device can send a packet to the second network device over one of the links of the first LAG and send the packet via the selected link. The network device may apply a selection mechanism, such as round robin, load balancing, or hashing, on the packet to select the link.

Accordingly, the network device can send a subsequent packet over another link. Since all of these links can be used in parallel, if the capacity of each of these links is Y Gbps (e.g., 10 Gbps) and there are 4 links in the first LAG, the network device can operate the first LAG as a virtual link between the first and second network devices with a capacity of 4 Y Gbps (e.g., 40 Gbps). In the example in FIG. 1A, LAG 102 can correspond to the first LAG, and links 132, 134, 136, and 138 can correspond to the first set of links.

The network device can operate a second LAG comprising the first LAG and at least one high-capacity link between the network device and the second network device (operation 304). Here, the capacity of the high-capacity link can match the combined capacity of the first LAG. The second LAG can be an ML-LAG comprising the first LAG. To operate the second LAG, the network device can send packets to the second network device at an aggregated data rate of the links in the second LAG. Here, the virtual link corresponding to the first LAG can be used as a link in the second LAG. If the capacity of the virtual link corresponding to the first LAG is 4 Y Gbps (e.g., 40 Gbps), the capacity of the high-capacity link in the second LAG can be 4 Y Gbps. The first LAG may be formed between NICs with a port capacity of Y Gbps. On the other hand, the high-capacity link may be formed between respective NICs with a port capacity of 4 Y. In other words, the capacity of each of these links is 4 Y Gbps (e.g., 40 Gbps). If there are at least two links, including the virtual link corresponding to the first LAG, in the second LAG, the network device can operate the second LAG as another virtual link between the first and second network devices with a capacity of at least 8 Y Gbps (e.g., 80 Gbps). In this way, the second LAG can span a plurality of NICs on the network device. If one of the NICs becomes unavailable, the other NIC can continue to operate, thereby facilitating high availability to the second LAG. In the example in FIG. 1A, LAG 104 can correspond to the second LAG, and link 142 can correspond to the high-capacity link.

The network device can then determine the first and second control packets (e.g., packets 162 and 164 in FIG. 1A, respectively) received at the network device to be associated with the first and second LAGs, respectively, based on an indicator in the second control packet (operation 306). Here, the first and second control packets can be generated based on a LAG control protocol. For example, if the LAG control protocol is LACP, the first and second control protocols can be LACP PDUs. Since the first LAG is included in the second LAG, a port in the first LAG can be present in both the first and second LAGs. As a result, the port may receive respective control packets associated with both first and second LAGs. The second control packet can include an indicator indicating the control packet to be associated with the second LAG (e.g., associated with an ML-LAG). By detecting the identifier in the second control packet, the network device can determine the association between the control packets and their corresponding LAGs.

The network device can then configure the first and second LAGs based on the first and second control packets, respectively (operation 308). Here, the first and second control packets can include control information based on which the first and second LAGs are to be configured. When the network device receives the first control packet from the second network device, the network device can determine the capacity and operational information (e.g., whether full duplex communication is supported and which VLANs are configured) associated with the first LAG. Accordingly, the first network device can configure a respective port that is to be in the first LAG. For example, the first control packet can indicate that the port capacity (or port speed) for the first LAG should be 10 Gbps. Accordingly, the network device can configure a respective link of the first LAG with a capacity of 10 Gbps. On the other hand, when the network device receives the second control packet from the second network device, the network device can determine the capacity and operational information associated with the second LAG. Accordingly, the first network device can configure a respective port that is to be in the second LAG. For example, the second control packet can indicate that the port capacity for the second LAG should be 40 Gbps. Since the first LAG can be included in the second LAG, the virtual link representing the first LAG can be configured with a capacity of 40 Gbps.

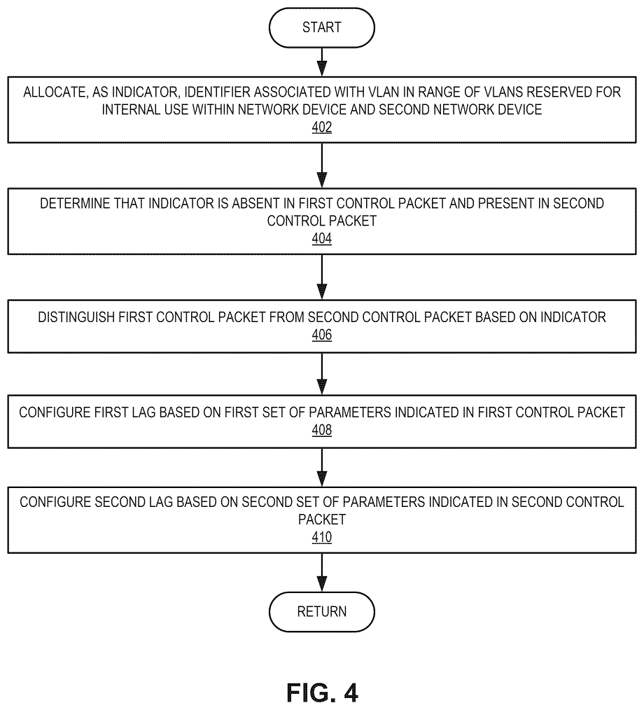

FIG. 4 presents a flowchart illustrating an example of a process of a network device distinguishing between control packets associated with an ML-LAG, in accordance with an aspect of the present application. During operation, the network device can allocate, as the indicator, an identifier associated with a VLAN (e.g., the identifier of VLAN 152 in FIG. 152) in a range of VLANs reserved for internal use within the network device and the second network device (operation 402). A respective internal VLAN can be reserved for internal use within the network device and may not be allocated for a client. Furthermore, once the internal VLAN is allocated for an ML-LAG (e.g., the second LAG of FIG. 3), it may remain allocated during the operation of ML-LAG. As a result, the internal VLAN can be used as the indicator associated with the second LAG and, hence, can be included in the control packet associated with an ML-LAG (e.g., control packet 164 in FIG. 1A).

Since the indicator is associated with an ML-LAG, the indicator may not be present in a control packet associated with an underlay LAG (e.g., control packet 162 in FIG. 1A). Hence, the network device can determine that the indicator is absent in the first control packet and present in the second control packet (operation 404). Based on the presence of the indicator in the second control packet, the network device can determine that it is associated with the second LAG. Therefore, the network device can distinguish the first control packet from the second control packet based on the indicator (operation 406). In the example in FIG. 1A, based on the presence of the identifier of VLAN 152, network device 110 can distinguish between control packets 162 and 164.

The first control packet can indicate configuration information associated with the first LAG. The configuration information can be represented by a first set of parameters. The configuration information can include, but is not limited to, port capacity (e.g., data transmission rate) of a port of the first LAG, the duplex mode, the flow control mechanism, maximum frame size (e.g., an Ethernet frame size), and a respective VLAN configured for the first LAG. Upon receiving the first control packet, the network device can configure the first LAG based on the first set of parameters indicated in the first control packet (operation 408). Similarly, the second control packet can indicate configuration information associated with the second LAG. The configuration information can be represented by a second set of parameters. Accordingly, the network device can configure the second LAG based on the second set of parameters indicated in the second control packet (operation 410).

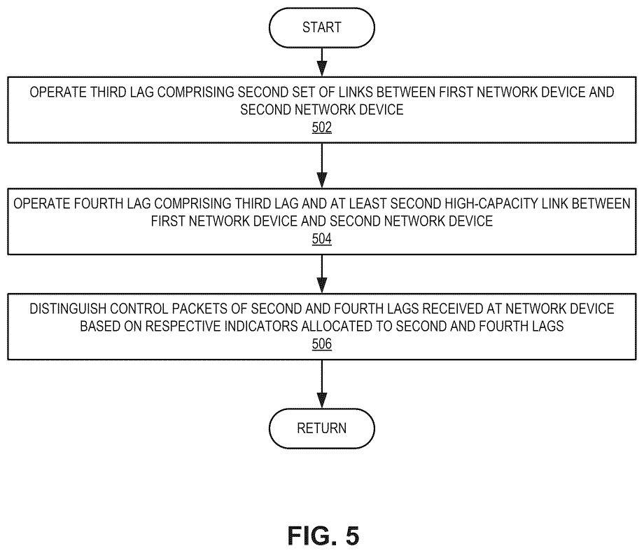

FIG. 5 presents a flowchart illustrating an example of a process of a network device operating a plurality of ML-LAGs, in accordance with an aspect of the present application. During operation, the network device can operate a third LAG comprising a second set of links between the first network device and the second network device (operation 502). Here, the second set of links can be distinct from the first set of links in FIG. 3. The second set of links can operate as another aggregated link between the network device and the second network device. To send a packet to the second network device, the network device can use one of the links of the third LAG and send the packet via the selected link. In the example in FIG. 1B, LAG 106 can correspond to the third LAG, and the links between NICs 118 and 128 can correspond to the second set of links. It should be noted that, in FIG. 1B, LAG 102 can correspond to the first LAG, and the links between NICs 114 and 124 can correspond to the first set of links

The network device can operate a fourth LAG comprising the third LAG and at least one high-capacity link between the network device and the second network device (operation 504). Here, the capacity of the high-capacity link can match the combined capacity of the third LAG. The fourth LAG can be an ML-LAG comprising the third LAG. Therefore, the virtual link corresponding to the third LAG can be used as a link in the fourth LAG. In the example in FIG. 1B, LAG 108 can correspond to the fourth LAG, and link 144 can correspond to the high-capacity link. There can be another ML-LAG 104, which can correspond to the second LAG of FIGS. 3, 4, and 5, between network devices 110 and 120. The network device can distinguish between the control packets of the second and fourth LAGs received at the network device based on respective indicators associated with the second and fourth LAGs (operation 506). In the example in FIG. 1B, ML-LAGs 104 and 108 can be associated with internal VLANs 152 and 154, respectively. Respective identifiers of VLANs 152 and 154 can then be included in corresponding control packets 166 and 168 as indicators. Accordingly, network device 110 can distinguish between control packets 166 and 168 based on respective indicators of ML-LAGs 104 and 108.

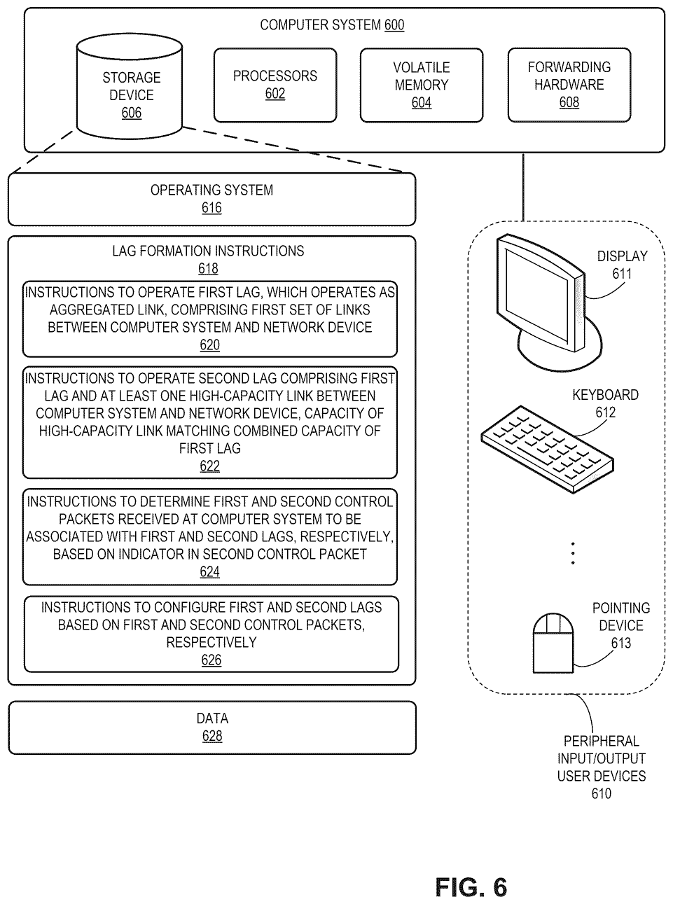

FIG. 6 illustrates an example of a computing system supporting an ML-LAG between network devices, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a Ternary Content Addressable Memory (TCAM). Storage device 606 includes a non-transitory computer-readable storage medium and stores an operating system 616, LAG formation instructions 618, and data 630. Computer system 600 may include fewer or more entities or instructions than those shown in FIG. 6.

LAG formation instructions 618 can include instructions, which when executed by computer system 600, can cause computer system 600 to perform methods and/or processes described in this disclosure. Computer system 600 can be a network device, such as network device 110 in FIGS. 1A, 1B, and 1C. Specifically, LAG formation instructions 618 may include instructions 620 to operate a first LAG, which operates as an aggregated link, comprising a first set of links between computer system 600 and a network device. In the example in FIG. 1A, the network device can correspond to network device 120, and the first set of links can correspond to links 132, 134, 136, and 138.

Furthermore, LAG formation instructions 618 may also include instructions 622 to operate a second LAG comprising the first LAG and at least one high-capacity link between computer system 600 and the network device. Here, the capacity of the high-capacity link can match the combined capacity of the first LAG. The second LAG can be an ML-LAG comprising the first LAG. In the example in FIG. 1A, LAG 104 can correspond to the second LAG, and link 142 can correspond to the high-capacity link.

Moreover, LAG formation instructions 618 may include instructions 624 to determine the first and second control packets received at computer system 600 to be associated with the first and second LAGs, respectively, based on an indicator in the second control packet. The second control packet can include an indicator indicating the control packet to be associated with the second LAG (e.g., associated with an ML-LAG). By detecting the identifier in the second control packet, the network device can determine the association between the control packets and their corresponding LAGs. In the example in FIG. 1A, network device 110 can determine control packets 162 and 164 to be associated with LAG 102 and MC-LAG 104, respectively, based on an indicator in control packet 164.

Furthermore, LAG formation instructions 618 may also include instructions 626 to configure the first and second LAGs based on the first and second control packets, respectively. Here, the first and second control packets can include control information based on which the first and second LAGs are to be configured. In the example in FIG. 1A, network device 102 can configure LAG 102 based on control packet 162 and configure ML-LAG 104 based on control packet 164. Data 630 can include any data that is required as input, or that is generated as output by the methods, operations, communications, and/or processes described in this disclosure.

Specifically, data 630 can include information associated with a respective member device in a LAG and an MC-LAG, such as the allocation of an internal VLAN to a corresponding MC-LAG. Data 630 can also include control information exchanged between computer system 600 and the network device (e.g., control information in control packets 162, 164, 166, 168, and 170 in FIGS. 1A, 1B, and 1C).

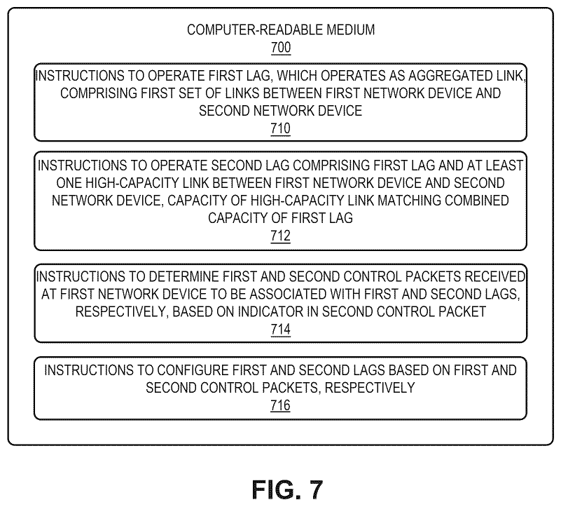

Computer system 600 and LAG formation instructions 618 may include more instructions than those shown in FIG. 6. For example, LAG formation instructions 618 can also store instructions for identifying respective control packets associated with a plurality of ML-LAGs 104 and 108 of FIG. 1B; identifying a control packet associated with an ML-LAG with a statically configured LAG of FIG. 1C; forming an MC-LAG based on a sequence of configurations of FIG. 2; the operations depicted in the flowcharts of FIGS. 3, 4, and 5; and the instructions of non-transitory CRM 700 in FIG. 7.

FIG. 7 illustrates an example of a CRM supporting an ML-LAG between network devices, in accordance with an aspect of the present application. CRM 700 can include one or more non-transitory computer-readable mediums or devices storing instructions that when executed by a computer or processor cause the computer or processor to perform a method. Therefore, the instructions in CRM 700 can be stored in one or more non-transitory computer-readable mediums or devices. CRM 700 can store instructions 710 to operate a first LAG, which operates as an aggregated link, comprising a first set of links between a first network device and a second network device. In the example in FIG. 1A, the network device can correspond to network device 120, and the first set of links can correspond to links 132, 134, 136, and 138. CRM 700 can also include instructions 712 to operate a second LAG comprising the first LAG and at least one high-capacity link between the first network device and the second network device. Here, the capacity of the high-capacity link can match the combined capacity of the first LAG. In the example in FIG. 1A, LAG 104 can correspond to the second LAG, and link 142 can correspond to the high-capacity link.

CRM 700 can include instructions 714 to determine the first and second control packets received at the first network device to be associated with the first and second LAGs, respectively, based on an indicator in the second control packet. In the example in FIG. 1A, network device 110 can determine control packets 162 and 164 to be associated with LAG 102 and MC-LAG 104, respectively, based on an indicator in control packet 164. CRM 700 can additionally include instructions 716 to configure the first and second LAGs based on the first and second control packets, respectively. In the example in FIG. 1A, network device 102 can configure LAG 102 based on control packet 162 and configure ML-LAG 104 based on control packet 164.

CRM 700 may include more instructions than those shown in FIG. 7. For example, CRM 700 can also store instructions for identifying respective control packets associated with a plurality of ML-LAGs 104 and 108 of FIG. 1B; identifying a control packet associated with an ML-LAG with a statically configured LAG of FIG. 1C; forming an MC-LAG based on a sequence of configurations of FIG. 2; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device. During operation, the network device can operate a first LAG comprising a first set of links between the network device and a second network device. Here, the first set of links can operate as an aggregated link between the network device and the second network device. The network device can operate a second LAG comprising the first LAG and at least a high-capacity link between the network device and the second network device. The capacity of the high-capacity link can match the combined capacity of the first LAG. The network device can determine the first and second control packets received at the first network device to be associated with the first and second LAGs, respectively, based on an indicator in the second control packet. The network device can then configure the first and second LAGs based on the first and second control packets, respectively.

In a variation on this aspect, the network device can operate the first LAG by operating the first LAG between a first NIC of the first network device and a second NIC of the second network device. The network device can also operate the second LAG further by operating the high-capacity link between a third NIC of the first network device and a fourth NIC of the second network device.

In a variation on this aspect, the network device can determine the first and second control packets to be associated with the first and second LAGs, respectively, by determining that the indicator is present in the second control packet and absent in the first control packet. The network device can then distinguish the second control packet from the first control packet based on the indicator.

In a variation on this aspect, the network device can configure the first and second LAGs by configuring the first LAG based on a first set of parameters indicated in the first control packet and configuring the second LAG based on a second set of parameters indicated in the second control packet.

In a variation on this aspect, the first and second control packets can include Link Aggregation Control Protocol (LACP) protocol data units (PDUs) associated with the first and second LAGs, respectively.

In a variation on this aspect, the network device can allocate, as the indicator, an identifier associated with a VLAN in a range of VLANs reserved for internal use within the first and second network devices.

In a variation on this aspect, the network device can operate a third LAG comprising a second set of links between the first network device and the second network device. The network device can also operate a fourth LAG comprising the third LAG and at least a second high-capacity link between the first network device and the second network device. The network device can then distinguish control packets of the second and fourth LAGs received at the first network device based on respective indicators allocated to the second and fourth LAGs.

In a variation on this aspect, the network device can configure the first LAG and the second LAG based on a predefined configuration sequence. Here, the predefined configuration sequence can include configuring the second LAG, configuring the first LAG as being incorporated into the second LAG, allocating the first set of links to the first LAG, and allocating the high-capacity link to the second LAG.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
operating, by a first network device, a first link-aggregation group (LAG) comprising a first set of links between the first network device and a second network device, wherein the first set of links operate as an aggregated link between the first network device and the second network device;
operating a second LAG comprising the first LAG and at least a high-capacity link between the first network device and the second network device, wherein a capacity of the high-capacity link matches to a combined capacity of the first LAG;
determining first and second control packets received at the first network device to be associated with the first and second LAGs, respectively, based on an indicator in the second control packet; and
configuring the first and second LAGs based on the first and second control packets, respectively.

2. The method of claim 1,
wherein operating the first LAG further comprises operating the first LAG between a first network interface controller (NIC) of the first network device and a second NIC of the second network device; and
wherein operating the second LAG further comprises operating the high-capacity link between a third NIC of the first network device and a fourth NIC of the second network device.

3. The method of claim 1, wherein determining the first and second control packets to be associated with the first and second LAGs, respectively, further comprises:
determining that the indicator is present in the second control packet and absent in the first control packet; and
distinguishing the second control packet from the first control packet based on the indicator.

4. The method of claim 1, wherein configuring the first and second LAGs further comprises:
configuring the first LAG based on a first set of parameters indicated in the first control packet; and
configuring the second LAG based on a second set of parameters indicated in the second control packet.

5. The method of claim 1, wherein the first and second control packets include Link Aggregation Control Protocol (LACP) protocol data units (PDUs) associated with the first and second LAGs, respectively.

6. The method of claim 1, further comprising allocating, as the indicator, an identifier associated with a virtual local area network (VLAN) in a range of VLANs reserved for internal use within the first and second network devices.

7. The method of claim 1, further comprising:
operating a third LAG comprising a second set of links between the first network device and the second network device;
operating a fourth LAG comprising the third LAG and at least a second high-capacity link between the first network device and the second network device; and
distinguishing control packets of the second and fourth LAGs received at the first network device based on respective indicators allocated to the second and fourth LAGs.

8. The method of claim 1, further comprising configuring the first LAG and the second LAG based on a predefined configuration sequence;
wherein the predefined configuration sequence comprises:
configuring the second LAG;
configuring the first LAG as being incorporated into the second LAG;
allocating the first set of links to the first LAG; and
allocating the high-capacity link to the second LAG.

9. A non-transitory computer-readable storage medium storing instructions to:
operate, by a first network device, a first link-aggregation group (LAG) comprising a first set of links between the first network device and a second network device, wherein the first set of links operate as an aggregated link between the first network device and the second network device;
operate a second LAG comprising the first LAG and at least a high-capacity link between the first network device and the second network device, wherein a capacity of the high-capacity link matches to a combined capacity of the first LAG;
determine first and second control packets received at the first network device to be associated with the first and second LAGs, respectively, based on an indicator in the second control packet; and
configure the first and second LAGs based on the first and second control packets, respectively.

10. The non-transitory computer-readable storage medium of claim 9,
wherein operating the first LAG further comprises operating the first LAG between a first network interface controller (NIC) of the first network device and a second NIC of the second network device; and
wherein operating the second LAG further comprises operating the high-capacity link between a third NIC of the first network device and a fourth NIC of the second network device.

11. The non-transitory computer-readable storage medium of claim 9, wherein, to determine the first and second control packets to be associated with the first and second LAGs, respectively, the instructions are further to:
determine that the indicator is present in the second control packet and absent in the first control packet; and
distinguish the second control packet from the first control packet based on the indicator.

12. The non-transitory computer-readable storage medium of claim 9, wherein, to configure the first and second LAGs, the instructions are further to:
configure the first LAG based on a first set of parameters indicated in the first control packet; and
configure the second LAG based on a second set of parameters indicated in the second control packet.

13. The non-transitory computer-readable storage medium of claim 9, wherein the first and second control packets include Link Aggregation Control Protocol (LACP) protocol data units (PDUs) associated with the first and second LAGs, respectively.

14. The non-transitory computer-readable storage medium of claim 9, wherein the instructions are further to allocate, as the indicator, an identifier associated with a virtual local area network (VLAN) in a range of VLANs reserved for internal use within the first and second network devices.

15. The non-transitory computer-readable storage medium of claim 9, wherein the instructions are further to:
operate a third LAG comprising a second set of links between the first network device and the second network device;
operate a fourth LAG comprising the third LAG and at least a second high-capacity link between the first network device and the second network device; and
distinguish control packets of the second and fourth LAGs received at the first network device based on respective indicators allocated to the second and fourth LAGs.

16. The non-transitory computer-readable storage medium of claim 9, wherein the instructions are further to configure the first LAG and the second LAG based on a predefined configuration sequence;
wherein the predefined configuration sequence comprises:
configuring the second LAG;
configuring the first LAG as being incorporated into the second LAG;
allocating the first set of links to the first LAG; and
allocating the high-capacity link to the second LAG.

17. A computer system, comprising:
one or more processing resources; and
a non-transitory computer-readable storage medium storing instructions that when executed by the one or more processing resources cause the computer system to perform a method, the method comprising:
operating a first link-aggregation group (LAG) comprising a first set of links between the computer system and a second computer system, wherein the first set of links operate as an aggregated link between the computer system and the second computer system;
operating a second LAG comprising the first LAG and at least a high-capacity link between the computer system and the second computer system, wherein a capacity of the high-capacity link matches to a combined capacity of the first LAG;
determining first and second control packets received at the computer system to be associated with the first and second LAGs, respectively, based on an indicator in the second control packet; and
configuring the first and second LAGs based on the first and second control packets, respectively.

18. The computer system of claim 18,
wherein operating the first LAG further comprises operating the first LAG between a first network interface controller (NIC) of the computer system and a second NIC of the second computer system; and
wherein operating the second LAG further comprises operating the high-capacity link between a third NIC of the computer system and a fourth NIC of the second computer system.

19. The computer system of claim 18, wherein determining the first and second control packets to be associated with the first and second LAGs, respectively, further comprises:
determining that the indicator is present in the second control packet and absent in the first control packet; and
distinguishing the second control packet from the first control packet based on the indicator.

20. The computer system of claim 18, wherein the method further comprises:
operating a third LAG comprising a second set of links between the first network device and the second network device;
operating a fourth LAG comprising the third LAG and at least a second high-capacity link between the first network device and the second network device; and
distinguishing control packets of the second and fourth LAGs received at the first network device based on respective indicators allocated to the second and fourth LAGs.
